(19) United States
(12) Patent Application Publication
(10) Pub. No.: US 2007/0142220 A1
(43) Pub. Date: Jun. 21, 2007

(54) Method for preparing ethylene polymerization catalysts

(75) Inventors: Myung Ahn Ok, Daejeon (KR); Dae Ho Shin, Daejeon (KR); Jong Sok Hahn, Daejeon (KR); Mal woo Lee, Daejeon (KR); Seoung Woong Ryu, Daejeon (KR)

Correspondence Address: DARBY & DARBY P.C., P. O. BOX 5257, NEW YORK, NY, 10150-5257, US

(73) Assignee: SK CORPORATION, SEOUL (KR)

(21) Appl. No.: 10/598,147

(22) PCT Filed: Mar. 7, 2005
(86) PCT No.: PCT/KR05/00631

§ 371 Date: Aug. 18, 2006

(30) Foreign Application Priority Data
Mar. 11, 2004 (KR) 10/2004-00166604

(51) Int. Cl. B01J 37/00

(52) U.S. Cl. 502/104; 502/103

(57) ABSTRACT

The present invention relates to a method of preparing an ethylene polymerization catalyst, which comprises reacting a solid reaction product of magnesium halide (such as magnesium chloride), alcohol, an organic magnesium compound, and a halogen compound with a transition metal compound and an electron donor. When ethylene and a-olefin are co-polymerized by slurry polymerization in the presence of the above catalyst, the amount of wax component extracted by the polymerization solvent is very low, and the polymer particles do not agglomerate. The catalyst is prepared in the form of so uniform particles that the resultant polymer has uniform particle morphology, thus increasing bulk density.

### BACKGROUND OF THE INVENTION

1. Field of the Invention

The present invention relates to a method of preparing an ethylene polymerization catalyst. More particularly, the present invention pertains to a method of preparing an ethylene polymerization catalyst which is suitable for use in slurry polymerization in conjunction with a co-catalyst to homo-polymerize ethylene or co-polymerize ethylene and α-olefin having 3 to 8 carbons. Thus, high density polyethylene or medium density polyethylene, having a density of 0.935 or more, can be produced at high yield.

2. Description of the Related Art

Through gas or solution polymerization, medium density polyethylene having a density on the order of 0.930-0.945 g/cc and low density polyethylene having a density on the order of 0.920-0.930 g/cc are easily prepared. However, when ethylene and α-olefin are co-polymerized through slurry polymerization using an aliphatic hydrocarbon as a polymerization solvent in the presence of a Ziegler-Natta catalyst, the amount of wax component extracted or dissolved by the polymerization solvent is considerably increased in proportion to increasing the amounts of co-monomers. In addition, final polymer particles may agglomerate, resulting in clogged process lines. For the reason as described above, limitations are particularly imposed on the preparation of medium density polyethylene having densities of 0.945 g/cc or less. Further, the use of the Ziegler-Natta catalyst having non-uniform particles leads to non-uniform polymer particle morphology, decreasing the bulk density of the polymer.

Typically, ethylene polymerization has been industrially conducted in the presence of a Ziegler-Natta catalytic system comprising a main catalyst composed of a transition metal of Groups IVB to VIB in the periodic table and a co-catalyst having an organoaluminum compound. To prepare a catalyst exhibiting high activity for ethylene polymerization, methods of supporting halide of a transition metal, such as titanium tetrachloride, to magnesium chloride, have been commonly used.

In this regard, U.S. Pat. No. 4,347,158 discloses a method of preparing a catalyst from magnesium chloride and titanium tetrachloride using a ball mill or vibration mill. In addition, U.S. Pat. Nos. 4,071,674, 4,315,874, and 4,399,054 disclose a method of preparing a solid catalyst, by dissolving magnesium chloride in alcohol and then reacting it with a large amount of titanium tetrachloride.

However, since the catalyst thus obtained is in the form of non-uniform particles, the copolymer of ethylene and α-olefin obtained by slurry polymerization in the presence of the above catalyst also has non-uniform particle morphology, thus decreasing bulk density. As well, a soluble component extracted by the polymerization solvent may exist in a large quantity. Hence, the above catalyst is unsuitable for use in the preparation of medium density polyethylene having a density of 0.945 g/cc or less.

U.S. Pat. No. 4,330,649 to Mitsui Petrochemical Co. Ltd., Japan, discloses that magnesium chloride is dissolved in 2-ethylhexylalcohol, and then re-precipitated in a large amount of titanium tetrachloride in the presence of an electron donor, to prepare a solid catalyst suitable for the production of medium density polyethylene through slurry polymerization. As such, the electron donor is exemplified by benzoic acid ethylester. Further, a method of using an electron donor such as alkyl phthalate to prepare a catalyst for improving the properties of the polymer is disclosed in U.S. Pat. Nos. 4,847,227, 4,970,186, and 5,130,284. Furthermore, U.S. Pat. Nos. 3,953,414 and 4,111,835 disclose a method of preparing a catalyst by spraying and drying a magnesium compound to form a spherical support.

However, the above methods are disadvantageous because the prepared catalyst has insufficient activity and unsatisfactory co-polymerizability. Also, the methods involve complicated preparation procedures, and may cause environmental problems due to the use of the large amount of titanium tetrachloride.

Meanwhile, In Korean Patent Laid-open No. 2002-56819, it is proposed that an electron donor such as phosphor or silane compound is reacted with an organic magnesium compound to prepare a catalyst, and alkyl halide is used upon polymerization to pre-activate the active polymerization sites in the catalyst, thereby broadening the molecular weight distribution. However, the above patent is disadvantageous in that because the use of the above catalyst results in solvent-extracted or dissolved wax components and agglomerated polymer particles, such a catalyst is unsuitable for preparation of medium density ethylene copolymer.

### SUMMARY OF THE INVENTION

Leading to the present invention, intensive and thorough research into polymerization catalysts, carried out by the present inventors aiming to avoid the problems encountered in the related art, led to the development of a method of preparing an ethylene polymerization catalyst that dramatically reduces a wax components extracted by a polymerization solvent, and that does not cause agglomeration of polymer particles when co-polymerizing ethylene and α-olefin through slurry polymerization, thus easily obtaining medium density polyethylene.

Accordingly, an object of the present invention is to provide a method of preparing an ethylene polymerization catalyst that can suppress the formation of active sites which causes the production of a polymer having a low molecular weight (especially, containing a large amount of co-monomer), among non-uniform active sites present in a Ziegler-Natta catalyst, whereby medium density polyethylene can be easily prepared at high yield through slurry polymerization.

Another object of the present invention is to provide a method of preparing an ethylene polymerization catalyst in the form of uniform particles, so that the resultant polymer has uniform particle morphology and thus has a high bulk density.

In order to accomplish the above objects, the present invention provides a method of preparing an ethylene polymerization catalyst, comprising
(a) (a1) reacting magnesium halide with alcohol in the presence of a hydrocarbon solvent,
   (a2) reacting the resulting product solution from the step (a1) with dialkylmagnesium, and
   (a3) reacting the resulting product from the step (a2) with alkyl halide or silane halide, to give a magnesium complex;
(b) reacting the magnesium complex with a titanium compound, to give a magnesium-titanium complex; and
(c) reacting the magnesium-titanium complex with an electron donor.

### DESCRIPTION OF THE PREFERRED EMBODIMENTS

Hereinafter, a detailed description will be given of the present invention.

According to the present invention, a method of preparing an ethylene polymerization catalyst is provided. In the presence of the ethylene polymerization catalyst of the present invention, ethylene may be homo-polymerized or ethylene and α-olefin may be co-polymerized through slurry polymerization to obtain high density or medium density polyethylene at high yield.

The ethylene polymerization catalyst of the present invention comprises powder type solid particles obtained by reacting a solid reaction product of magnesium halide (such as magnesium chloride), alcohol, an organic magnesium compound, and a halogen compound with a transition metal compound and an electron donor.

Specifically, the ethylene polymerization catalyst is prepared by contacting or reacting the following components:

[A] magnesium complex containing magnesium, halogen and alcohol(alkoxy) group

[B] tetravalent titanium compound

[C] electron donor.

In the magnesium complex A, a molar ratio of Mg and Cl ranges from 1:0.5 to 1:2, and a molar ratio of Mg and alkoxy group (or alcohol) ranges from 1:0.2 to 1:2. The magnesium complex A is prepared by forming a complex of magnesium halide (component 1) and alcohol (component 2) at an appropriate molar ratio, and then reacting the above complex with dialkylmagnesium (component 3) and alkyl halide or silane halide (component 4) at an appropriate molar ratio.

Specifically, a solution resulting from reacting magnesium halide with alcohol in the presence of a hydrocarbon solvent, is slowly reacted with dialkylmagnesium at −30 to 100° C., and preferably, 0 to 50° C., which is then slowly reacted with alkyl halide or silane halide at −30 to 100° C., and preferably, 0 to 50° C., thereby obtaining a magnesium complex A. If the reaction temperature is lower than −30° C., the reaction insufficiently occurs, and thus, the effects of adding the components are hardly attained. Meanwhile, if the temperature is higher than 100° C., it is difficult to uniformly form the catalyst particles due to the formation of precipitates, resulting in non-uniform polymer particle morphology.

The components 1, 2, 3 and 4 used for preparation of the magnesium complex A are particularly described, below.

Component 1: Magnesium Halide represented by MgX₂

In the above formula, X is a halogen element belonging to Group VII in the periodic table, for example, Cl or Br. Magnesium halide is exemplified by anhydrous magnesium chloride. In particular, anhydrous magnesium chloride having a relatively large surface area, and preferably, 5 m²/g or more, is suitable for the formation of a desired magnesium-alcohol complex.

Component 2: Aliphatic Alcohol represented by R¹OH

In the above formula, R¹ is an alkyl radical having 1 to 10 carbons. Aliphatic alcohol includes, for example, methyl alcohol, ethyl alcohol, n-propyl alcohol, iso-propyl alcohol, n-butyl alcohol, iso-butyl alcohol, 2-butyl alcohol, n-pentyl alcohol, amyl alcohol, n-hexyl alcohol, n-heptyl alcohol, n-octyl alcohol, 2-ethylhexyl alcohol, etc. Preferably, methyl alcohol, ethyl alcohol or 2-ethylhexyl alcohol is used.

Component 3: Dialkylmagnesium represented by MgR²R³ or MgR²R³.(AlR⁴₃)

In the above formula, R², R³, and R⁴, which are the same or different, respectively are an alkyl radical having 1 to 10 carbons. Dialkylmagnesium includes, for example, butylethylmagnesium and dibutylmagnesium.

Component 4: Alkyl Halide 4a represented by R⁵X or Silane Halide 4b represented by R⁵ₘSiX₄₋ₘ

In the above formula, R⁵ is an alkyl radical having 1 to 5 carbons, X is Cl, Br or I as a halogen element belonging to Group VII in the periodic table, and m is an integer from 0 to 3. Alkylhalide 4a includes, for example, chloromethane, chloroethane, 1-chloropropane, 2-chloropropane, 1-chlorobutane, 2-chlorobutane, 1-chloro-2-methylpropane, 2-chloro-2-methylpropane, 1-chloropentane, 2-chloropentane, 3-chloropentane, 1-chloro-2-methylbutane, 1-chloro-3-methylbutane, 2-chloro-2-methylbutane, 2-chloro-3-methylbutane, etc. In addition, silane halide 4b includes, for example, tetrachlorosilane, methyltrichlorosilane, dimethyldichlorosilane, trimethylchlorosilane, ethyltrichlorosilane, diethyldichlorosilane, triethylchlorosilane, propyltrichlorosilane, dipropyltrichlorosilane, tripropylchlorosilane, butylchlorosilane, trichlorosilane, tert-butyldimethylchlorosilane, pentylchlorosilane, etc.

The titanium compound B is a tetravalent titanium compound represented by TiX₄ (wherein X is a halogen element belonging to Group VII in the periodic table, such as Cl or Br, or an alkoxy radical, such as OC₂H₅, OC₃H₇, or OC₄H₉), and includes, for example, titanium tetrachloride (TiCl₄).

The electron donor C is an organic acid ester compound represented by R⁶(COO)ₙR⁷ₘR⁸ₙ₋ₘ, wherein R⁶ is saturated hydrocarbons, unsaturated hydrocarbons, alicyclic hydrocarbons or aromatic hydrocarbons having 1 to 18 carbons, R⁷ and R⁸, which are the same or different, respectively are an alkyl radical having 1 to 18 carbons, and n and m, which are the same or different, respectively are an integer of 1 or 2 (m≦n). The organic acid ester compound includes, for example, benzoic acid ethylester, and diisobutylphthalate.

In the preparation of the ethylene polymerization catalyst, the magnesium complex [A] produced as mentioned above is reacted with the titanium compound [B] to form a complex of magnesium compound and titanium compound to which the electron donor [C] is added.

As such, a molar ratio of the magnesium complex [A] and the titanium compound [B] ranges from 1:0.5 to 1:10, and preferably, from 1:1 to 1:6. When the molar ratio is less than 0.5, it is difficult to sufficiently attain the catalytic activity. On the other hand, if the molar ratio exceeds 10, there is required an additional step for recovery of the excess remaining non-reactive titanium compound.

Further, a molar ratio of magnesium complex [A] and electron donor [C] ranges from 1:0.01 to 1:0.5, and preferably, 1:0.05 to 1:0.2. If the molar ratio is less than 0.01, a solvent-extracted component is produced in a large amount upon co-polymerization of ethylene and α-olefin, or polymer particles may agglomerate. On the other hand, if the molar ratio exceeds 0.5, the catalytic activity is significantly reduced.

The catalyst obtained by the method of the present invention can suppress the formation of active sites which causes the production of a polymer having a low molecular weight (especially, containing a large amount of co-monomer), among non-uniform active sites present in a Ziegler-Natta catalyst. As a result, when ethylene and α-olefin are co-polymerized through slurry polymerization in the presence of the catalyst of the present invention, wax component extracted by the polymerization solvent hardly exists, and the polymer particles do not agglomerate, thus easily obtaining medium density polyethylene or high density polyethylene at high yield. In addition, with the aim of preparing the catalyst in the form of uniform particles, the magnesium-alcohol complex is reacted with organic magnesium and alkyl halide (or silane halide) before being reacted with the titanium compound. Therefore, the resultant polymer has uniform particle morphology in the presence of the above catalyst, increasing the bulk density thereof.

A better understanding of the present invention may be obtained in light of the following examples which are set forth to illustrate, but are not to be construed to limit the present invention.

The solid catalytic components were analyzed in accordance with the following procedures.

1. Analysis of Mg, Al, Ti and Si Components

Amounts of Mg, Al, Ti and Si were analyzed using ICP (Inductively Coupled Plasma).

2. Analysis of Cl component

The amount of Cl was analyzed using combustion ion chromatography.

Various properties of an ethylene-αolefin copolymer, resulting from slurry polymerization in the presence of the catalyst of the present invention, were measured in accordance with the following procedures.

1. Bulk Density

The bulk density was measured according to ASTM D 1895.

2. Melt Flow Index

The melt flow index was measured according to ASTM D 2839.

3. Density

The density was measured using a density gradient tube according to ASTM D 1505.

4. Hexane-Extracted Component

The prepared copolymer was weighed and then loaded into a Soxlet device using hexane as a solvent. After the solvent was refluxed for 8 hr, the copolymer was weighed again, and the difference in weight of the copolymer was measured, and thus, the amount of component extracted by hexane was determined.

### EXAMPLE 1

Preparation of Solid Catalyst 1

A 500 ml glass reactor, equipped with a filter, was provided with a stirrer, and then sufficiently filled with nitrogen. Subsequently, 150 ml of purified n-decane and 7 g (73.7 mmol) of anhydrous magnesium chloride (MgCl₂, Toho Titanium Co.) were loaded into the reactor, to which 34.5 ml (221 mmol) of 2-ethylhexyl alcohol was slowly added in droplets while being stirred at room temperature. The temperature was increased to 130° C. to melt the solid substances, thus obtaining a uniform reaction solution, which was then reacted while being stirred for an additional 2 hr. Thereafter, the temperature was decreased to 20-30° C., and 49 ml (73.7 mmol Mg) of butylethylmagnesium (Magala, 21 wt % n-heptane solution) was slowly added in droplets to the reaction solution for 30 min, and the reaction was carried out for an additional 1 hr. The slurry thus obtained was added with 15.4 ml (147.4 mmol) of butyl chloride (BuCl), and the reaction occurred at the same temperature for 1 hour. The temperature was decreased to 10° C., and the reaction solution was added with 24 ml (221 mmol) of titanium tetrachloride (TiCl₄), and then stirred at room temperature for 30 min. The temperature was increased to 80° C. for 1 hour, and 1.1 g (7.37 mmol) of benzoic acid ethylester was added and then the temperature was increased to 90° C., after which the reaction was carried out at 90° C. for 2 hr.

After the completion of the reaction, the operation of the stirrer was stopped to precipitate the slurry, and then the non-reacted supernatant was removed using the filter. Thereafter, the remaining portion was added with 150 ml of purified heptane, stirred for 15 min, and then the resulting supernatant was removed in the same manner as above to purify the solid substances. After the temperature was decreased to room temperature, the above purification was further performed twice using purified hexane.

Vacuum drying was conducted at room temperature for 2 hr, yielding pale yellow catalyst powder. The yield of the resulting catalyst was 28.6 g, in which the amounts of Mg and Ti were found to be 11.1 wt % and 5.1 wt %, respectively, and the amount of Cl was found to be 31.5 wt %, according to the component analysis.

The analytic results for the composition of the catalyst are given in Table 1, below.

Preparation of Ethylene Copolymer

Into a 2.0 L stainless reactor, 1.2 L of hexane and 1.5 mmol triethylaluminum (TEAL) were loaded, and the reaction temperature was increased to 65° C. The reaction solution was added with 15 mg of the catalyst, to which 500 ml of hydrogen were added. Shortly after 10 g of 1-butene was added to the above reaction solution, ethylene was supplied to initiate the polymerization. During the polymerization, the reactor was maintained at 70° C. and at a pressure of 6 kg/cm² for 1 hr. After the completion of the polymerization, the resultant white polymer powder was separated from the polymer slurry and then dried using a vacuum oven at 60° C. for 8 hr. The yield of the polymer was 251 g, and also, the bulk density and the melt flow index of the polymer were 0.27 g/cc and 2.7 g/10 min, respectively. Further, the polymer had the density of 0.941 g/cc. The amount of hexane-extracted component was 1.4 wt %. The properties of the copolymer are summarized in Table 2, below.

### EXAMPLE 2

A catalyst was prepared in the same manner as in Example 1, with the exception that butyl chloride was used in an amount of 7.7 ml (73.7 mmol). The analytic results for the composition of the catalyst are given in Table 1, below.

An ethylene copolymer was prepared in the same manner as in Example 1, with the exception of using the catalyst prepared in the present example. The properties of the copolymer are summarized in Table 2, below.

Example 3

A catalyst was prepared in the same manner as in Example 1, with the exception that butyl chloride was not used. The analytic results for the composition of the catalyst are given in Table 1, below.

An ethylene copolymer was prepared in the same manner as in Example 1, with the exception of using the catalyst prepared in the present example. The properties of the copolymer are summarized in Table 2, below.

### EXAMPLE 4

A catalyst was prepared in the same manner as in Example 3, with the exception that butylethyl magnesium was used in an amount of 24.5 ml (36.9 mmol Mg). The analytic results for the composition of the catalyst are given in Table 1, below.

An ethylene copolymer was prepared in the same manner as in Example 1, with the exception of using the catalyst prepared in the present example. The properties of the copolymer are summarized in Table 2, below.

### EXAMPLE 5

Preparation of Solid Catalyst 2

A catalyst was prepared in the same manner as in Example 1, with the exception that methyltrichlorosilane (MeSiCl₃) was used, instead of BuCl.

That is, a 500 ml glass reactor, equipped with a filter, was provided with a stirrer, and then sufficiently filled with nitrogen. Subsequently, 150 ml of purified n-decane and 7 g (73.7 mmol) of anhydrous magnesium chloride were loaded into the reactor, to which 34.5 ml (221 mmol) of 2-ethylhexyl alcohol was slowly added in droplets while being stirred at room temperature. The temperature was increased to 130° C. to melt the solid substances, thus obtaining a uniform reaction solution, which was then reacted while being stirred for an additional 2 hr. Thereafter, the temperature was decreased to 20-30° C., and 49 ml (73.7 mmol Mg) of butylethylmagnesium (Magala, 21 wt % n-heptane solution) was slowly added in droplets to the reaction solution for 30 min, and the reaction was carried out for an additional 1 hr. The slurry thus obtained was added with 8.6 ml (73.7 mmol) of methyltrichlorosilane, and the reaction was carried out at the same temperature for 1 hr. The temperature was decreased to 10° C., and the reaction solution was added with 24 ml (221 mmol) of titanium tetrachloride (TiCl₄), and then stirred at room temperature for 30 min. The temperature was increased to 80° C. for 1 hour, and 1.1 g (7.37 mmol) of benzoic acid ethylester was added and then the temperature was increased to 90° C., after which the reaction is carried out at 90° C. for 2 hr.

After the completion of the reaction, the operation of the stirrer was stopped to precipitate the slurry, and then the non-reacted supernatant was removed using the filter. Thereafter, the remaining portion was added with 150 ml of purified heptane, stirred for 15 min, and then the resulting supernatant was removed in the same manner as above to purify the solid substances. After the temperature was decreased to room temperature, the above purification was further performed twice using purified hexane.

Vacuum drying was conducted at room temperature for 2 hr, yielding pale yellow catalyst powder. The yield of the catalyst was 29.6 g, in which the amounts of Mg and Ti were found to be 10.6 wt % and 5.2 wt %, respectively, and the amounts of Si and Cl were found to be 2.4 wt % and 35.7 wt %, respectively, according to the component analysis.

The analytic results for the composition of the catalyst are given in Table 3, below.

Preparation of Ethylene Copolymer

An ethylene copolymer was prepared in the same manner as in Example 1, with the exception of using the catalyst obtained in the present example. The yield of the polymer was 237 g, and also, the bulk density and the melt flow index of the polymer were 0.28 g/cc and 2.3 g/10 min, respectively. Further, the polymer had the density of 0.939 g/cc. The amount of hexane-extracted component was 1.3 wt %. The properties of the copolymer are summarized in Table 4, below.

### EXAMPLE 6

A catalyst was prepared in the same manner as in Example 5, with the exception that butylethyl magnesium was used in an amount of 24.5 ml (36.9 mmol Mg). The analytic results for the composition of the catalyst are given in Table 3, below.

An ethylene copolymer was prepared in the same manner as in Example 5, with the exception of using the catalyst prepared in the present example. The properties of the copolymer are summarized in Table 4, below.

### COMPARATIVE EXAMPLE 1

Preparation of Catalyst

The catalyst was prepared in the same manner as in Example 1, excepting that neither butylethyl magnesium nor butyl chloride was not employed.

That is, a 500 ml glass reactor, equipped with a filter, was provided with a stirrer, and then sufficiently filled with nitrogen. Subsequently, 150 ml of purified n-decane and 7 g (73.7 mmol) of anhydrous magnesium chloride were loaded into the reactor, to which 34.5 ml (221 mmol) of 2-ethylhexyl alcohol was slowly added in droplets while being stirred at room temperature. The temperature was increased to 130° C. to melt the solid substances, thus obtaining a uniform reaction solution, which was then reacted while being stirred for an additional 2 hr. Thereafter, the temperature was decreased to 10° C., and the reaction solution was added with 24 ml (221 mmol) of titanium tetrachloride (TiCl₄) and stirred at room temperature for 30 min. The temperature was increased to 90° C. for 1 hour, after which the reaction was carried out at 90° C. for 2 hr.

After the completion of the reaction, the operation of the stirrer was stopped to precipitate the slurry, and then the non-reacted supernatant was removed using the filter. Thereafter, the remaining portion was added with 150 ml of purified heptane, stirred for 15 min, and then the resulting supernatant was removed in the same manner as above to purify the solid substances. After the temperature was decreased to room temperature, the above purification was further performed twice using purified hexane.

Vacuum drying was conducted at room temperature for 2 hr, yielding pale yellow catalyst powder. The yield of the catalyst was 12.6 g, in which the amounts of Mg and Ti were found to be 8.9 wt % and 4.6 wt %, respectively, and the amount of Cl was found to be 35.9 wt %, according to the component analysis.

The analytic results for the composition of the catalyst are given in Table 5, below.

Preparation of Ethylene Copolymer

An ethylene copolymer was obtained in the same manner as in Example 1, with the exception of using the catalyst prepared in the present comparative example. The yield of the vacuum dried copolymer was 150 g, and also, the bulk density and the melt flow index of the polymer were 0.19 g/cc and 1.3 g/10 min, respectively. Further, the polymer had the density of 0.938 g/cc, with severely agglomerated particles. The amount of hexane-extracted component was 19.6 wt %. The properties of the copolymer are summarized in Table 6, below.

### COMPARATIVE EXAMPLE 2

Preparation of Catalyst

A 500 ml glass reactor, equipped with a filter, was provided with a stirrer, and then sufficiently filled with nitrogen. Subsequently, 150 ml of purified n-decane and 7 g (73.7 mmol) of anhydrous magnesium chloride (MgCl₂, Toho Titanium Co.) were loaded into the reactor, to which 34.5 ml (221 mmol) of 2-ethylhexyl alcohol was slowly added in droplets while being stirred at room temperature. The temperature was increased to 130° C. to melt the solid substances, thus obtaining a uniform reaction solution, which was then reacted while being stirred for an additional 2 hr. Thereafter, the temperature was decreased to 20-30° C., and 11.1 ml (88.4 mmol) of diethylaluminumchloride (Et₂AlCl) was slowly added in droplets to the reaction solution for 30 min, and the reaction is carried out for an additional 1 hour. The slurry thus obtained was maintained at 10° C., added with 24 ml (221 mmol) of titanium tetrachloride (TiCl₄), and stirred at room temperature for 30 min. The temperature was increased to 90° C. for 1 hour, after which the reaction was carried out at 90° C. for 2 hr.

After the completion of the reaction, the operation of the stirrer was stopped to precipitate the slurry, and then the non-reacted supernatant was removed using the filter. Thereafter, the remaining portion was added with 150 ml of purified heptane, stirred for 15 min, and then the resulting supernatant was removed in the same manner as above to purify the solid substances. After the temperature was decreased to room temperature, the above purification was further performed twice using purified hexane.

Vacuum drying was conducted at room temperature for 2 hr, yielding pale yellow catalyst powder. The yield of the catalyst was 17.5 g, in which the amounts of Mg and Cl were found to be 8.2 wt % and 3.9 wt %, respectively, and the amounts of Si and Ti were found to be 3.3 wt % and 34.9 wt %, respectively, according to the component analysis.

The analytic results for the composition of the catalyst are given in Table 5, below.

Preparation of Ethylene Copolymer

An ethylene copolymer was prepared in the same manner as in Example 1, with the exception of using the catalyst prepared in the present comparative example. The yield of the vacuum dried polymer was 132 g. In addition, the bulk density and the melt flow index of the polymer were 0.18 g/cc and 1.8 g/10 min, respectively. Further, the polymer had the density of 0.941 g/cc, with severely agglomerated particles. The amount of hexane-extracted component was 22.0 wt %. The properties of the copolymer are summarized in Table 6, below.

### COMPARATIVE EXAMPLE 3

Preparation of Catalyst

A 500 ml glass reactor, equipped with a filter, was provided with a stirrer, and then sufficiently filled with nitrogen. Subsequently, 150 ml of purified n-decane and 7 g (73.7 mmol) of anhydrous magnesium chloride (MgCl₂, Toho Titanium Co.) were loaded into the reactor, to which 34.5 ml (221 mmol) of 2-ethylhexyl alcohol was slowly added in droplets while being stirred at room temperature. The temperature was increased to 130° C. to melt the solid substances, thus obtaining a uniform reaction solution, which was then reacted while being stirred for an additional 2 hr. Subsequently, the temperature was decreased to 20-30° C., and 11.1 ml (88.4 mmol) of diethylaluminumchloride (Et₂AlCl) was slowly added in droplets to the reaction solution for 30 min, and the reaction was carried out for an additional 1 hour. The slurry thus obtained was maintained at 10° C., added with 24 ml (221 mmol) of titanium tetrachloride (TiCl₄), and stirred at room temperature for 30 min. The temperature was increased to 80° C. for 1 hour, and 1.1 g (7.37 mmol) of benzoic acid ethylester was added and the temperature was increased to 90° C., after which the reaction was carried out at 90° C. for 2 hr.

After the completion of the reaction, the operation of the stirrer was stopped to precipitate the slurry, and then the non-reacted supernatant was removed using the filter. Thereafter, the remaining portion was added with 150 ml of purified heptane, stirred for 15 min, and then the resulting supernatant was removed in the same manner as above to purify the solid substances. After the temperature was decreased to room temperature, the above purification was further performed twice using purified hexane.

The resultant solid particles were transferred into a separate flask, and then vacuum dried at room temperature for 2 hr, yielding pale yellow catalyst powder. The yield of the catalyst was 17.1 g, in which the amounts of Mg and Cl were found to be 8.8 wt % and 4.1 wt %, respectively, and the amounts of Si and Ti were found to be 2.7 wt % and 34.3 wt %, respectively, according to the component analysis.

The analytic results for the composition of the catalyst are given in Table 5, below.

Preparation of Ethylene Copolymer

An ethylene copolymer was prepared in the same manner as in Example 1, with the exception of using the catalyst prepared in the present comparative example. The yield of the vacuum dried polymer was 97 g. In addition, the bulk density and the melt flow index of the polymer were 0.21 g/cc and 1.2 g/10 min, respectively. Further, the polymer had the density of 0.934 g/cc. The amount of hexane-extracted component was 8.5 wt %. The properties of the copolymer are summarized in Table 6, below.

TABLE 1

| | MgCl₂/2-EHA/MgR₂/ | Catalyst | |
|---|---|---|---|
| Ex. | BuCl/EB/TiCl₄ | Comp. (%) | Catalyst Yield (%) |
| No. | (Molar Ratio) | Mg/Ti/Cl | (Based On MgCl₂) |
| 1 | 1/3/1.0/2/0.1/3 | 11.1/5.1/31.5 | 408 |
| 2 | 1/3/1.0/1/0.1/3 | 10.3/5.3/31.6 | 398 |
| 3 | 1/3/1.0/0/0.1/3 | 9.5/6.1/30.8 | 318 |
| 4 | 1/3/0.5/0/0.1/3 | 8.5/6.3/32.8 | 254 |

TABLE 2

| | Polymer | Activity | Bulk | MI | | |
|---|---|---|---|---|---|---|
| Ex. | Yield | (Kg-PE/ | Density | (g/10 | Density | Hexane-Extracted |
| No. | (g) | g-cat) | (g/cc) | min) | (g/cc) | Component(wt %) |
| 1 | 251 | 16.7 | 0.27 | 2.7 | 0.941 | 1.4 |
| 2 | 282 | 18.8 | 0.26 | 2.2 | 0.938 | 1.7 |
| 3 | 309 | 20.6 | 0.26 | 1.9 | 0.946 | 2.7 |
| 4 | 201 | 13.4 | 0.24 | 3.0 | 0.935 | 3.1 |

TABLE 3

| | MgCl₂/2-EHA/MgR₂/ | Catalyst | |
|---|---|---|---|
| Ex. | MeSiCl₃/EB/TiCl₄ | Comp. (%) | Catalyst Yield (%) |
| No. | (Molar Ratio) | Mg/Ti/Si/Cl | (Based On MgCl₂) |
| 5 | 1/3/1.0/1/0.1/3 | 10.6/5.2/2.4/35.7 | 422 |
| 6 | 1/3/0.5/1/0.1/3 | 8.7/5.3/2.7/38.7 | 256 |

TABLE 4

| | Polymer | Activity | Bulk | MI | | |
|---|---|---|---|---|---|---|
| Ex. | Yield | (Kg-PE/ | Density | (g/10 | Density | Hexane-Extracted |
| No. | (g) | g-cat) | (g/cc) | min) | (g/cc) | Component(wt %) |
| 5 | 237 | 15.8 | 0.28 | 2.3 | 0.939 | 1.1 |
| 6 | 393 | 26.2 | 0.26 | 2.0 | 0.938 | 1.3 |

TABLE 5

| | MgCl₂/2-EHA/ | Catalyst | |
|---|---|---|---|
| C. Ex. | Et₂AlCl/EB/TiCl₄ | Comp. (%) | Catalyst Yield (%) |
| No. | (Molar Ratio) | Mg/Ti/Al/Cl | (Based On MgCl₂) |
| 1 | 1/3/0.0/0.0/3 | 8.9/4.6/0.0/35.9 | 180 |
| 2 | 1/3/1.2/0.0/3 | 8.2/3.9/3.3/34.9 | 250 |
| 3 | 1/3/1.2/0.1/3 | 8.8/4.1/2.7/34.3 | 244 |

TABLE 6

| C. | Polymer | Activity | Bulk | MI | | |
|---|---|---|---|---|---|---|
| Ex. | Yield | (Kg-PE/ | Density | (g/10 | Density | Hexane-Extracted |
| No. | (g) | g-cat) | (g/cc) | min) | (g/cc) | Component(wt %) |
| 1 | 150 | 10.0 | 0.19 | 1.3 | 0.938 | 19.6 |
| 2 | 132 | 8.8 | 0.18 | 1.8 | 0.941 | 22.0 |
| 3 | 97 | 6.5 | 0.21 | 1.2 | 0.934 | 8.5 |

As is apparent from Tables 1 to 6, when ethylene is homo-polymerized or ethylene and α-olefin are co-polymerized through slurry polymerization in the presence of the catalyst prepared according to the method of the present invention, high density polyethylene having a density of 0.945 g/cc or more, or medium density polyethylene having a density of 0.930-0.945 g/cc can be easily prepared at high yield.

Before the magnesium-alcohol complex is reacted with the titanium compound, it is reacted with organic magnesium and alkyl halide (or silane halide) in advance, thereby improving the physical properties of the polymer. In addition, the catalyst of the present invention, which is merely pretreated with organic magnesium, results in a much smaller amount of hexane-extracted component and a higher bulk density, compared to the conventional catalysts.

Particularly, when medium density polyethylene is prepared through slurry polymerization in the presence of the inventive catalyst in the form of uniform particles, the resultant polymer has uniform particle morphology, thus further increasing bulk density, compared to the conventional Ziegler-Natta catalysts. As well, the solvent-extracted component exists in a dramatically decreased amount, and agglomeration of the polymer particles may be prevented.

As described above, the present invention provides a method of preparing an ethylene polymerization catalyst. The catalyst of the present invention is advantageous because it inhibits the formation of active sites which causes the production of a polymer having a low molecular weight (especially, containing a large amount of co-monomer), among non-uniform active sites present in a Ziegler-Natta catalyst. As a result, when the ethylene copolymer is prepared in the presence of the catalyst of the present invention, that is, when ethylene and α-olefin are co-polymerized by slurry polymerization in the presence of the above catalyst, the amount of wax component extracted by the polymerization solvent is very low, and the polymer particles do not agglomerate. In addition, medium density polyethylene or high density polyethylene is easily prepared at high yield. Further, the magnesium-alcohol complex is reacted with organic magnesium and alkyl halide (or silane halide) before being reacted with the titanium compound, so that the catalyst is prepared in the form of uniform particles. Thereby, the resultant polymer has uniform particle morphology, thus increasing bulk density.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of preparing an ethylene polymerization catalyst, comprising:
(a) (a1) reacting magnesium halide with alcohol in the presence of a hydrocarbon solvent,
(a2) reacting the resulting product solution from the step (a1) with dialkylmagnesium, and
(a3) reacting the resulting product from the step (a2) with alkyl halide or silane halide, to give a magnesium complex;
(b) reacting the magnesium complex with a titanium compound, to give a magnesium-titanium complex; and
(c) reacting the magnesium-titanium complex with an electron donor.

2. The method as set forth in claim 1, wherein the magnesium halide is a compound represented by a formula of MgX₂, in which X is a halogen element belonging to Group VII in the periodic table.

3. The method as set forth in claim 1, wherein the alcohol is a compound represented by a formula of R¹OH, in which R¹ is an alkyl radical having 1 to 10 carbons.

4. The method as set forth in claim 1, wherein the dialkylmagnesium is a compound represented by a formula of MgR²R³ or MgR²R³.(AlR⁴₃), in which R², R³ and R⁴, which are the same or different, respectively are an alkyl radical having 1 to 10 carbons.

5. The method as set forth in claim 1, wherein the alkyl halide is a compound represented by a formula of R⁵X, in which R⁵ is an alkyl radical having 1 to 5 carbons, and X is a halogen element belonging to Group VII in the periodic table.

6. The method as set forth in claim 1, wherein the silane halide is a compound represented by a formula of R⁵ₘSiX₄₋ₘ, in which R⁵ is an alkyl radical having 1 to 5 carbons, X is a halogen element belonging to Group VII in the periodic table, and m is an integer ranging from 0 to 3.

7. The method as set forth in claim 1, wherein the titanium compound is a compound represented by a formula of TiX₄, in which X is a halogen element belonging to Group VII in the periodic table, or an alkoxy radical selected from among OC₂H₅, OC₃H₇ and OC₄H₉.

8. The method as set forth in claim 1, wherein the electron donor is an organic acid ester compound represented by a formula of R⁶(COO)ₙR⁷ₘR⁸ₙ₋ₘ, in which R⁶ is saturated hydrocarbons, unsaturated hydrocarbons, alicyclic hydrocarbons or aromatic hydrocarbons having 1 to 18 carbons, R⁷ and R⁸, which are the same or different, respectively are an alkyl radical having 1 to 18 carbons, and n and m, which are the same or different, respectively are an integer of 1 or 2 (m≦n).

9. The method as set forth in claim 1, wherein the steps (a2) and (a3) are carried out at −30 to 1 00° C.

10. The method as set forth in claim 1, wherein a molar ratio of the magnesium complex and the titanium compound ranges from 1:0.5 to 1:10, and the step (b) is carried out at −20 to 100° C.

11. The method as set forth in claim 1, wherein a molar ratio of the magnesium complex and the electron donor ranges from 1:0.01 to 1:0.5.
